(19) United States
(12) Patent Application Publication
(10) Pub. No.: US 2015/0008348 A1
(43) Pub. Date: Jan. 8, 2015

(54) BULLET VALVE FOR CONTROLLED FLUID FLOWS

(71) Applicant: MAGNA POWERTRAIN OF AMERICA, INC., Troy, MI (US)

(72) Inventor: Darrell F. Greene, Bradford (CA)

(21) Appl. No.: 14/380,468

(22) PCT Filed: Feb. 22, 2013
(86) PCT No.: PCT/US13/27408

§ 371 Date: Aug. 22, 2014

Related U.S. Application Data
(60) Provisional application No. 61/602,048, filed on Feb. 22, 2012.

(51) Int. Cl. F16K 1/12; F16K 31/383

(52) U.S. Cl. CPC F16K 1/126; F16K 31/383
USPC 251/62; 251/324

(57) ABSTRACT

A valve (10) for selectively diverting flow from a source to another path for use in vehicles. The valve includes a valve plunger (20) axially movable in a housing (12) between a closed position in which an annulus (28) of the valve plunger blocks the inner diameter of an inlet pipe (14) and serves as a hydrodynamic surface to move the fluid entering the inlet pipe smoothly over the valve elements, including a control chamber (40) that contacts with a fixed base of the valve member. The control chamber is connected by an inlet orifice (32) to the inlet pressure and to an external control orifice (52) connection having a low-pressure side such that the control pressure in the control chamber is variable between 100% and 0% of the inlet pressure.

### CROSS-REFERENCE TO RELATED APPLICATIONS

This application claims the benefit of U.S. Provisional Application No. 61/602,048, filed Feb. 22, 2012.

### FIELD OF THE INVENTION

The present invention relates generally to valves for use in controlling the flow of a fluid. More particularly, the present disclosure relates to a particular design for a fluid control valve for use in controlling a fluid flow in a fluid control circuit such as that used in an engine cooling system or system where there is a need to control the flow of a fluid.

### BACKGROUND OF THE INVENTION

Annular valves are generally known to be suitable for regulating flow and pressure of a fluid. Generally, an annular valve is designed to work against a column of fluid pressure and resist cavitation. The closure member generally has a conical shape and is movable in an axial direction of the tube conduit or other structure in which the fluid is flowing. Typically, the fluid flow goes around the closure member when the closure member is axially moved in a direction away from the exit opening (i.e., the valve is open).

### SUMMARY OF THE INVENTION

In one exemplary embodiment, there is disclosed a valve assembly having a valve housing having an inlet and an outlet, the valve for selectively directing flow from a source. The valve includes a valve plunger supported by a plurality of guide fins in the housing and being axially movable in the housing between a closed position in which an annulus of the valve plunger blocks the inlet and an open position wherein the valve plunger does not block the inlet; and wherein the valve plunger includes an outer curved surface defining the annulus which outer curved surface is capable of serving as a hydrodynamic surface when a fluid entering the inlet pipe moves smoothly over the valve plunger.

In one exemplary embodiment, the valve assembly further includes a control chamber having a first pressure supplied to it at an inlet orifice and having a second pressure supplied to the control chamber from an external control orifice connection, the second pressure having a low-pressure side (favorably the inlet of the pump) such that the control pressure in the control chamber is variable between 100% and 0% of the inlet pressure.

In another exemplary embodiment, the valve assembly further includes a fixed base member located toward the outlet of the valve assembly, within the housing, wherein the control chamber is defined by the movable valve plunger and the fixed base. In another exemplary embodiment, the fixed base and the valve plunger define the control chamber that functions as a piston and the fixed base includes an outer surface facing the outlet and having a converging outer surface for converging a flowing fluid into the outlet pipe.

In another exemplary embodiment, the valve assembly operates such that the net force on the valve plunger is determined by pressure on the hydrodynamic face of the plunger versus the control chamber pressure and the relative areas of the faces of the control chamber are fixed such that the position of the valve plunger can be controlled solely by the restriction created by the external control orifice pressure in the control chamber and is independent of the inlet pressure.

In one exemplary embodiment, the valve assembly includes an actuator for controlling the valve assembly and more particularly, for controlling the pressure of the fluid in the control chamber by controlling the location of the valve plunger relative to the fixed base. The actuator may be any one of a solenoid, a voice-coil motor, a rotational device, a lead-screw, and a memory metal for actuating the valve assembly between the open and closed positions. In particular, the control actuator is located in communication with the control orifice connection to define a varying restriction therein for allowing a portion of the fluid to escape from the control chamber and/or the control orifice connection to reduce the pressure of the fluid in the control chamber.

In the one exemplary embodiment, the valve assembly is operable by the actuator to change the position of the valve plunger without having to overcome or be subject to fluctuations in the forces produced by pressure on the valve plunger face (i.e., the inlet pressure and its variations). In another exemplary embodiment, the actuator may be located in the fixed base.

In another exemplary embodiment, the valve assembly may be used in a cooling system. In another exemplary embodiment, the valve assembly may be used in a cooling system for an internal combustion engine such as those used in passenger vehicles. In particular, the valve assembly may be in fluid communication with an outlet of a water pump in a cooling system for selectively supplying the cooling water to a water jacket of the engine. In one exemplary embodiment, the valve assembly is controlled by the engine control module. In particular, the actuator of the control valve is controlled by a controller, such as the engine control module.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective graphic view of an exemplary bullet vale and housing system in accordance with the present disclosure;

FIG. 2 is a partial, cross-sectional, graphic view and the bullet valve and housing of the exemplary embodiment of FIG. 1 in accordance with the present disclosure;

FIG. 3 is a partial, perspective graphic view of the bullet valve of FIG. 1 with the housing removed depicting the flow of a fluid over the bullet valve in accordance with the present disclosure;

FIG. 4 is a schematic diagram of a fluid pressure control circuit for the bullet valve operation in accordance with the present disclosure;

FIG. 5 is a perspective graphic view of the exemplary bullet valve and phantom housing in accordance with the present disclosure;

FIG. 6 is a control pressure graphic view of the exemplary bullet valve depicting valve force pressure settings versus control pressure in accordance with the present disclosure;

FIG. 7 is an alternate perspective graphic view of the exemplary bullet valve and housing system of FIG. 1 in accordance with the present disclosure;

FIG. 8 is a further alternate perspective graphic view of the exemplary bullet valve and housing system of FIG. 1 in accordance with the present disclosure;

FIG. 9 is a partial, cross-sectional, graphic view and the bullet valve and housing of the exemplary embodiment of FIG. 1 in accordance with the present disclosure in a closed position; and

FIG. 10 is a partial, cross-sectional, graphic view and the bullet valve and housing of the exemplary embodiment of FIG. 1 in accordance with the present disclosure in an open position showing the flow of a fluid.

### DETAILED DESCRIPTION OF THE PREFERRED EMBODIMENTS

The following description of the preferred embodiment(s) is merely exemplary in nature and is in no way intended to limit the invention, its application, or uses.

Referring in general to all of the figures, the present disclosure and teachings described herein provide for a valve that is utilized as part of an engine cooling system which valve is operable to control the flow of a fluid flowing at an inlet pipe using the inner diameter (ID) of the inlet pipe. It should be understood that it is possible to rearrange parts of the valve and it is also possible to integrate the valve in any other type of system to perform a similar function using the disclosure and teachings of the present application.

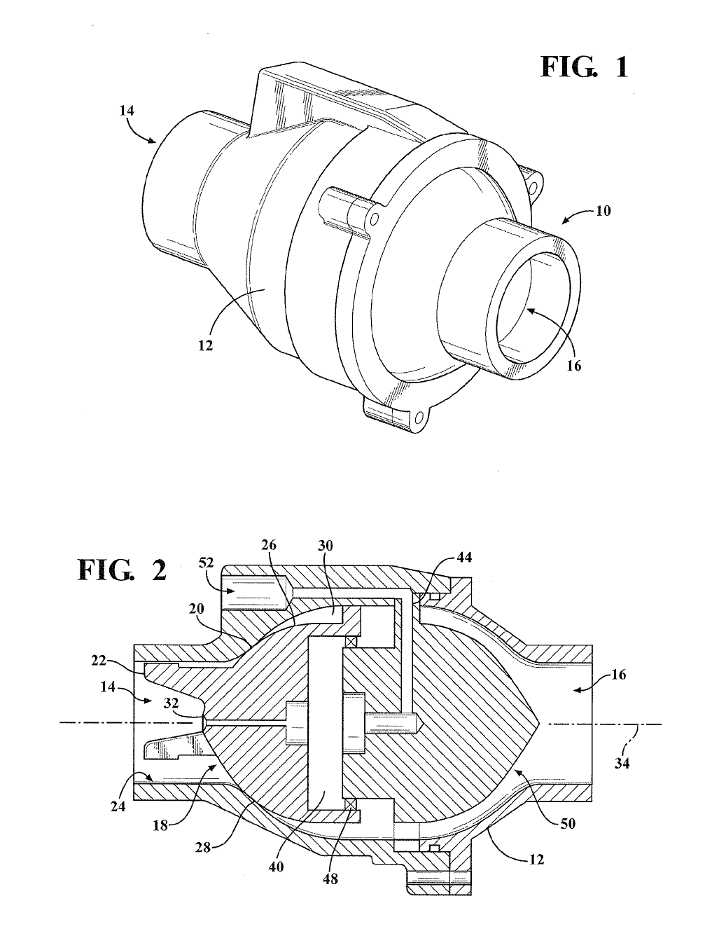

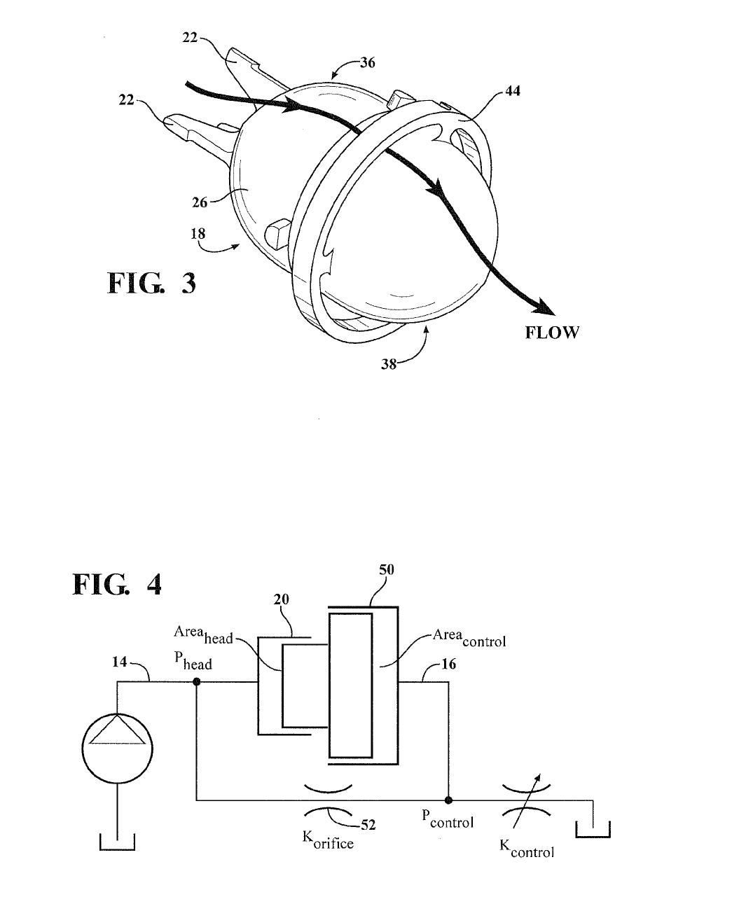

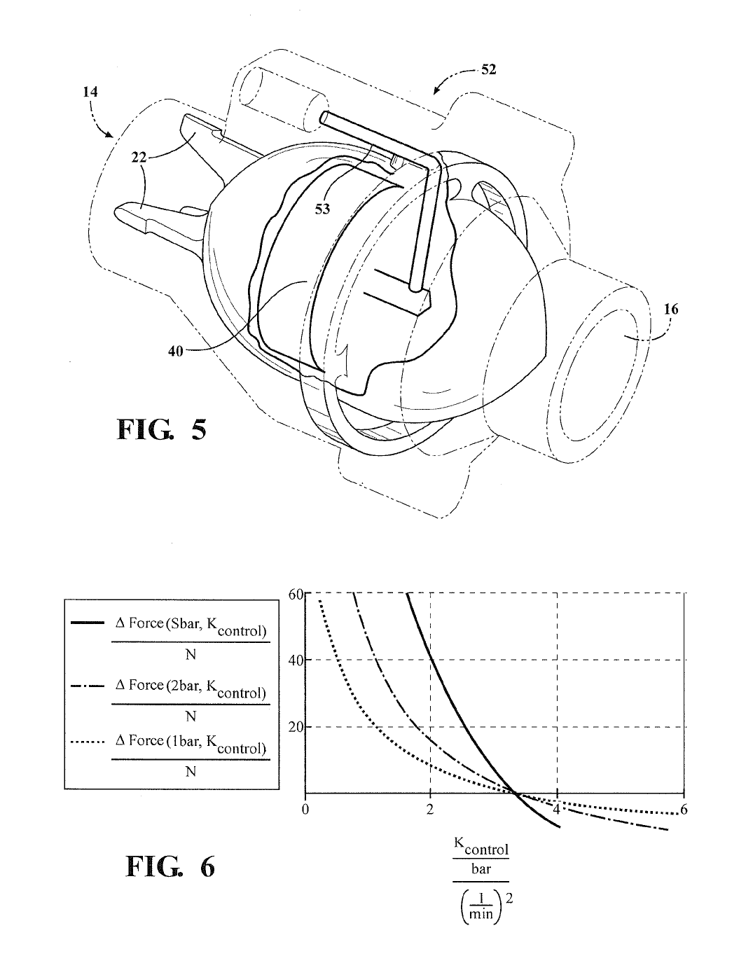

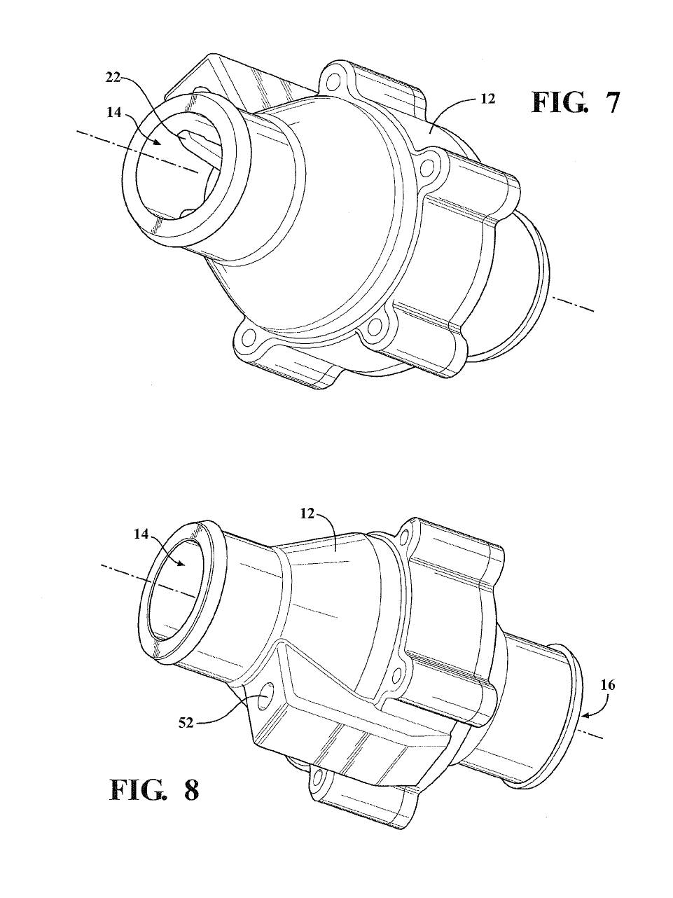

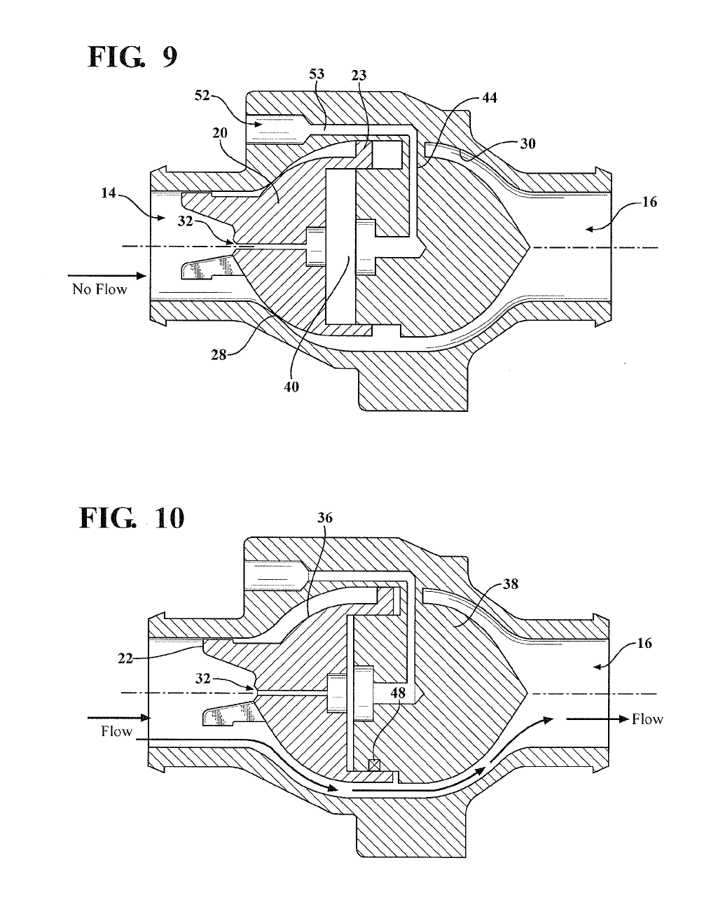

Referring in particular to FIGS. 1, 7 and 8, there is disclosed a valve assembly 10 including a housing 12 and having an inlet 14 and an outlet 16. The valve assembly 10 includes a bullet type valve portion 18 which functions similarly to an annular valve. Referring now in particular to FIGS. 2, 3, 5, 9 and 10, the internal components of the valve assembly 10 can be seen more clearly. The valve assembly 10 includes a valve plunger 20 that is axially movable within the inlet 14 end of the housing 12. The valve plunger 20 is supported by a plurality of guide fins 22 (while three guide fins are disclosed, it is possible to use more) and can be positioned to block or open the inlet 14 on inner diameter 24 (ID) of the inlet 14. The valve plunger 20 includes an outer surface 26 having a generally billet-type shape modified by the guide fins 22. The generally round shape includes and defines an annulus portion 28 that matches the ID 24 of the inlet 14 to provide a good and fluid-tight seal when the valve plunger 20 is located in the closed position (FIG. 9). The outer surface 26 of the valve plunger 20 and the housing 12 are designed so that when a fluid is flowing around the valve plunger 20, the outer surface 26 will function as a hydrodynamic surface to move the fluid entering the inlet 14 smoothly over and around the valve plunger 20 and the other valve elements. As such, the valve plunger 20 is disclosed as a generally round member that is axially movable within a chanter 30 of the housing 12. The valve member may be made of any known or appropriate materials using any known or appropriate manufacturing process.

The valve plunger 20 includes an inlet orifice 32 extending along an axis 34 of the valve plunger 20 from a leading edge 36 (nearest the inlet of the housing) to a trailing edge 38 or side (furthest away from the inlet of the housing) which functions to communicate inlet fluid pressure to a control chamber 40 located on the trailing edge 38 of the valve plunger 20, as best shown in FIGS. 2, 9 and 10. The valve plunger 20 further includes a plurality of guide fins 42 located toward the trailing edge 38 for further supporting the valve plunger 20 within the housing chanter 30.

The trailing edge 38 defines a wall of the valve plunger 20 that defines a portion of a control chamber 40. The valve plunger 20 functions as a piston-type member within the chamber 30 of the housing 12. The control chamber 40 located between the valve plunger 20 and a fixed base 46 is sealed between the valve plunger 20 and the fixed base 46, as best shown in FIG. 2, by any known or appropriate type of seal device 48 including but not limited to such seals as a mechanical, close fit between the pans, a ring seal, a diaphragm seal, a piston seal or any other type of seal appropriate for containing the inlet fluid pressure within the control chamber 40.

The fixed base 46 is attached to one-half of the housing 12 to form an outlet assembly 50 and also includes a conical outer surface design that functions with the shape of the housing chamber 30 to converge the flowing fluid into the outlet 16. Similar to the inlet orifice 32 of the valve assembly, the outlet side also has a flow path (as best shown in FIGS. 2, 3, 5, 9 and 10) that also functions substantially as a hydrodynamic surface to smoothly move the fluid passing through the housing chamber 30 and smoothly over the fixed base 46 and to the outlet 16.

The inlet and an external control orifice 52 connect to the control chamber 40. The external control orifice 52 is connected to a low-pressure side (favorably the inlet of the pump) such that the control pressure is variable between 100% and 0% of the inlet pressure. Since the valve plunger 20 moves axially within the housing chamber 30 depending upon the balance of pressures on the sides of the valve plunger 20, it can be appreciated that varying the control valve will vary the pressure of the fluid in the control chamber 40 and thereby control the position of the valve plunger 20 in the chamber 30 of the housing 12 and therefore control the flow of fluid across the valve assembly 10. Restriction-needle valve, ball valve, lever, finger, etc.—anything that will vary it between closed and open—any type of actuator that moves the valve between open and closed.

Additionally, in one alternate embodiment, it is contemplated that the valve assembly 10 may optionally include a spring member for biasing the valve plunger 20 toward a particular position, such as the closed position shown in FIGS. 2 and 9. The force of the spring member is chosen to be relatively light so that it biases the valve member toward the closed position with only a sufficient and necessary force to allow the valve member to be normally biased closed but also so the valve member may still be operated.

As best shown in the control pressure graph of FIG. 6 for various pressure settings, the valve assembly of the present disclosure is balanced when the valve plunger 20 is in the closed position since the inlet orifice 32 allows the applied pressure to be applied to both sides of the valve plunger 20. In one exemplary embodiment, it is contemplated that the cross-sectional areas of the inlet orifice 32 and the control orifice are selected so that the forces applied to each side of the valve plunger 20 are balanced in the closed position and the valve plunger 20 does not move. As the control orifice 52 is opened from the closed position and fluid is allowed to flow through the control orifice 52 and exit the control chamber 40, the pressure in the control chamber 40 will drop and the balance of pressures on the valve plunger 20 will move the valve plunger 20 from the closed position within the housing chamber 30 (FIGS. 2 and 9) toward the open position (FIG. 10).

As can be seen in FIG. 6, the graphed inlet pressure is divided by the ratio of the effective cross-sections of the inlet orifice 32 and the control orifice 52 such that the control of the valve plunger 20 is further enhanced. In one particular embodiment, it is contemplated that a controller mechanism may be used for controlling the position of the control valve allowing fluid to exit the control orifice connection in response to a signal from a controller. As the net force on the plunger is determined by pressure on the hydrodynamic face of the plunger versus the control chamber pressure, and the relative areas of the face and control chamber fixed, the position of the valve (and thus the control of flow) can be controlled solely by the restriction created by the external control orifice, and is independent of the inlet pressure. Accordingly, control of the external control orifice and the amount of fluid allowed to exit will control the pressure drop in the control chamber and the operation of the valve assembly.

Accordingly, in one embodiment, control of the valve assembly 10 is accomplished directly by an actuator for operating a valve on the control orifice 52 connection. The actuator may be of any known or appropriate type such as a solenoid, voice-coil motor, rotational device, lead-screw, memory metal, or other type, because the actuator must only serve to change the position of the control valve on the control orifice 52 connection without having to overcome, or be subject to fluctuations in forces produced by pressure variations on the valve plunger 20 face. Accordingly, the present design requires only a very small amount of force to control the control valve thereby allowing for a relatively very small actuator to be used to control the valve assembly 10. Accordingly, there is a significant improvement of the valve assembly 10 according to the present disclosure since it allows for a relatively much smaller package requirement and a relatively much lower electrical power draw than compared to known valves used in similar applications without the inclusion of the control chamber as disclosed and taught herein. In a further alternate embodiment, it is contemplated that the actuator and valve may be incorporated in the fixed base 46 and may vary the closure of the cross section of the control orifice 52 connection as compared to the cross section of the inlet orifice 32.

It is further contemplated that an infinitely variable restriction in the control orifice 52 connection, or even multiple selective restrictions, may be used for controlling the valve assembly opening. Similarly, such control may be realized by a variety of valves controlled by, but not limited to an actuator as disclosed herein including, but not limited to, a solenoid, stepper-motor, wax-element motor, or memory metal/polymer material or other known or appropriate actuation device.

It should be understood from the present disclosure that the valve assembly 10 can be pressure controlled to open and close the valve assembly (i.e., to move the valve plunger 20 between the closed position (FIGS. 2 and 9) and the open position (FIG. 10). With the inlet pressure supplied to the valve assembly 10 and the valve plunger 20 in the closed position, inlet pressure is communicated via the inlet orifice 32 to the control chamber 40 and to the control orifice 52 connection such that the pressures on the valve plunger 20 are balanced based upon the effective cross sectional area of the sides of the valve plunger 20. As the actuator is supplied with a “signal” to open the control orifice valve, the pressure in the control chamber will drop and the valve plunger 20 will move from the closed position toward the open position and can be controlled by the ratio of the control orifice 52 opening to the inlet orifice 32 opening. When the orifice control valve is closed again the pressure in the control chamber 40 will rise again and the valve plunger 20 will return to the closed position.

Alternatively, the control orifice 52 may be fixed (or even closed) such that the valve plunger 20 is neutrally biased, or, biased toward a favored position (e.g., biased toward an open position as part of a failsafe application), or alternatively further biased by a biasing element such as a spring. FIG. 3 shows a hydraulic schematic for providing pressure control of the bullet valve of the present disclosure as described herein.

Any numerical values recited herein or in the figures are intended to include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “x′ parts by weight of the resulting polymeric blend composition” also contemplates a teaching of ranges of same recited amount of “x′ in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A valve assembly comprising:
a housing having an inlet and an outlet for selectively directing fluid from said inlet to said outlet;
a chamber formed in said housing and having an inner diameter of said inlet, said chamber and said outlet; and
a bullet valve portion movably positioned in said chamber and contained in said housing, wherein said bullet valve portion has an annulus portion configured to contact said inner diameter when said bullet valve portion is in a closed position and said annulus portion moves away from said inner diameter when said bullet valve portion moves to an open position.

2. The valve assembly of claim 1 further comprising:
a control chamber having a first pressure supplied to said control chamber at an inlet orifice and having a second pressure supplied to said control chamber from an external control orifice connection extending through said housing, the second pressure having a low-pressure side such that the control pressure and the control chamber is variable and controls the movement of the bullet valve portion between said open position, said closed position and any positions there between.

3. The valve assembly of claim 2 wherein said bullet valve portion has a fixed base member located within the chamber within the housing and wherein the bullet valve portion also includes a movable valve plunger in said chamber and said control chamber is located between said movable valve plunger and said fixed base member.

4. The valve assembly of claim 3 wherein the fixed base member and the valve plunger define the control chamber and function as a piston, wherein the fixed base member includes a trailing surface facing the outlet and creating a converging outer surface for converging a flowing fluid into said outlet.

5. The valve assembly of claim 4 wherein the net force on the valve plunger is determined by pressure on the hydrodynamic face of the valve plunger versus the pressure in said control chamber and the relative areas of the face portions of the control chamber are fixed such that the position of the valve plunger can be controlled solely by the restriction created by the external control orifice independent of the inlet pressure.

6. The valve assembly of claim 5 further comprising an actuator for controlling the valve assembly, wherein said actuator is at least one of a solenoid, a voice-coil motor, a rotational device, a lead-screw, and a memory metal for actuating the valve assembly between the open and closed positions.

7. A valve assembly comprising:
a housing having an inlet and an outlet for selectively directing fluid flow from a source through said inlet to said outlet;
a chamber formed in said housing and defined by an inner diameter extending along the surface of said chamber from said inlet, through said chamber and to said outlet;
a bullet valve portion having a fixed base member connected to the inner diameter of said chamber and a valve plunger movably connected to said fixed base member, wherein said valve plunger has an annulus configured to contact said inner diameter when said valve plunger of said bullet valve portion is in a closed position and said annulus portion moves away from said inner diameter when said valve plunger of said bullet valve portion moves to an open position thereby allowing fluid to flow from said inlet past said annulus portion through said chamber to said outlet;
a control chamber formed between said fixed base member and said valve plunger portion; and
an inlet orifice extending through said valve plunger portion to said control chamber for providing a first pressure to said control chamber and an external control orifice extending through said housing to said control chamber for providing a second pressure to said control chamber, wherein said first pressure and said second pressure create a variable pressure within said control chamber for causing said valve plunger to move with respect to said fixed base member, wherein said movement of said valve plunger with respect to said fixed base member causes said bullet valve portion to move between said open position and said closed position.

8. The valve assembly of claim 7 wherein the fixed base member and the valve plunger define the control chamber and function as a piston, wherein the fixed base member includes a trailing surface facing the outlet and creating a converging outer surface for converging a flowing fluid into said outlet.

9. The valve assembly of claim 8 wherein the net force on the valve plunger is determined by pressure on The hydrodynamic face of the valve plunger versus the pressure in said control chamber and the relative areas of the face portions of the control chamber are fixed such that the position of the valve plunger can be controlled by the restriction created by the external control orifice independent of the inlet pressure.

10. The valve assembly of claim 9 further comprising an actuator for controlling the valve assembly, wherein said actuator is at least one of a solenoid, a voice-coil motor, a rotational device, a lead-screw, and a memory metal for actuating the valve assembly between the open position and closed position.

11. A valve assembly having a valve housing having an inlet and an outlet, the valve for selectively directing flow from a source, the valve comprising:
a valve plunger supported by a plurality of guide fins in the housing and being axially movable in the housing between a closed position in which an annulus of the valve plunger blocks the inlet and an open position wherein the valve plunger does not block the inlet; and
wherein the valve plunger includes an outer curved surface defining the annulus which outer curved surface is capable of serving as a hydrodynamic surface when a fluid entering the inlet pipe moves smoothly over the valve plunger.

12. The valve assembly of claim 11 further comprising:
a control chamber having a first pressure supplied to it at an inlet orifice and having a second pressure supplied to the control chamber from an external control orifice connection, the second pressure having a low pressure side such that the control pressure in the control chamber is variable between 100% and 0% of the inlet pressure.

13. The valve assembly of claim 11 further comprising a fixed base member located toward the outlet of the valve assembly and within the housing and wherein the control chamber is defined by the movable valve plunger and the fixed base member.

14. The valve assembly of claim 13 wherein the fixed base member and the valve plunger defining the control chamber function as a piston and wherein the fixed base includes a trailing surface facing the outlet and forming a converging outer surface for converging a flowing fluid into the outlet.

15. The valve assembly of any of claim 14 wherein the net force on the valve plunger is determined by pressure on the hydrodynamic face of the plunger versus the control chamber pressure and the relative areas of the face and control chamber are fixed such that the position of re valve plunger can be controlled solely by the restriction created by the external control orifice and is independent of the inlet pressure.

16. The valve assembly of claim 15 wherein the actuator is at least one of a solenoid, a voice-coil molar, a rotational device, a lead-screw, and a memory metal for actuating the valve assembly between the open and closed positions.

17. The valve assembly of any of claim 11 wherein the valve assembly is operable by an actuator to change position of the valve plunger without having to overcome, or be subject to fluctuations in, forces produced by pressure on the valve plunger face.

18. The valve assembly of claim 17 wherein the actuator is located in the fixed base.
